(19) United States
(12) Patent Application Publication
(10) Pub. No.: US 2010/0067531 A1
(43) Pub. Date: Mar. 18, 2010

(54) APPARATUS AND METHOD FOR CONTROLLING INDEPENDENT CLOCK DOMAINS TO PERFORM SYNCHRONOUS OPERATIONS IN AN ASYNCHRONOUS NETWORK

(75) Inventors: Michael Stephen Thiems, Edwardsville, IL (US); Bruce A. Augustine, Lake in the Hills, IL (US)

Correspondence Address: PRASS LLP, 2661 Riva Road, Bldg. 1000, Suite 1044, ANNAPOLIS, MD, 21401, US

(73) Assignee: Motorola, Inc., Schaumburg, IL (US)

(21) Appl. No.: 12/212,355

(22) Filed: Sep. 17, 2008

(51) Int. Cl. H04L 12/56

(52) U.S. Cl. 370/395.62

(57) ABSTRACT

Method and apparatus are disclosed for synchronizing multimedia in asynchronous networks. In this invention, clock domains are first reduced to separate hardware clock correction circuits at the separate endpoints of an asynchronous network. At each end of the network node, the controllable input device such as a video device is synchronized to the non-controllable output device such as a set top box to prevent unknown or poor-quality alterations by the output device. Output device timestamp packets are regularly sent to the input device, which then adjusts its clock accordingly. The exchange of packets between input devices over the asynchronous network is then subjected to a software-based scheme to effectively synchronize these devices.

### BACKGROUND OF THE INVENTION

1. Field of the Invention

The present invention relates generally to the field of timing synchronization and, more particularly, to multiple synchronization mechanism to create effective synchronization between different clock sources.

2. Introduction

Encoder-to-decoder clock synchronization is an issue that arises in many different types of multimedia transmission systems. It is a particularly difficult issue in transmission over asynchronous packet-switched networks such as Ethernet/Internet. The encoder and decoder in the system agree on a nominal sample clock frequency, such as 16 KHz audio or 29.97 frames per second video. The encoder has a crystal clock source of a certain nominal frequency f_{ce} which runs at least one PLL/DLL, and the encoder creates its 16 KHz sample clock from this clock source. The decoder also has its own crystal clock source of nominal frequency f_{cd}, thru PLL/DLL, and then creates the decoder's 16 KHz sample clock. Encoder's audio ADC (analog-to-digital converter) uses its 16 KHz sample clock, encodes, transmits over network to decoder, which decodes and outputs to its audio DAC (digital-to-analog converter) which uses decoder's 16 KHz sample clock. The problem is that the crystal frequencies f_{ce} and f_{cd} are only nominal frequencies. Nevertheless, crystals have some tolerance in their frequencies (for example ±40 parts per million), plus further changes due to aging and temperature. Thus, while the actual crystals frequencies are both very close to 27 MHz, they are not likely to be exactly equal to one another. If the spec for each were ±50 ppm total, in the worst case the encoder could be 27,001,350 Hz and the decoder 26,998,650 Hz.

The asynchronous communication network does not provide a clock source which can be used to directly synchronize the two ends. Moreover, to make matters worse, the packet-switched network typically results in data transmission latency. While the network must be able to maintain the average data transmission rate, there is quite a bit of “jitter” in packet transmission times. This makes it somewhat more difficult for the decoder to determine the encoder's actual sample rate frequency.

### SUMMARY

Method and apparatus are disclosed for synchronizing multimedia in asynchronous networks. In this invention, clock domains are first reduced to separate hardware clock correction circuits at the separate endpoints of an asynchronous network. At each end of the network node, the controllable input device such as a video device is synchronized to the non-controllable output device such as a set top box to prevent unknown or poor-quality alterations by the output device. Output device timestamp packets are regularly sent to the input device, which then adjusts its clock accordingly. The exchange of packets between input devices over the asynchronous network is then subjected to a software-based scheme to effectively synchronize these devices.

### BRIEF DESCRIPTION OF THE DRAWINGS

FIG. 1 is an exemplary diagram that illustrates a network environment in accordance with a possible embodiment of the invention;

FIG. 2 is an exemplary diagram that illustrates a video device in accordance with a possible embodiment of the invention;

FIG. 3 is a format diagram of an RTP header in accordance with a possible embodiment of the invention;

FIG. 4 is a circuit equivalent of a multiple synchronization mechanism in accordance with a possible embodiment of the invention;

FIG. 5 is a flowchart showing a process to achieve hardware and software synchronization at a video device in accordance with a possible embodiment of the invention;

FIG. 6 is a flowchart showing hardware synchronization in accordance with a possible embodiment of the invention; and

FIG. 7 is a flowchart showing software synchronization in accordance with a possible embodiment of the invention.

### DETAILED DESCRIPTION

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

The invention concerns the use of two separate synchronization mechanisms on each endpoint of the asynchronous network. The first, Hardware-based Correction, actually changes the sample clock rate. The second, Software-based Correction, adjust the number of samples and/or timestamps before outputting them to a reproduction device.

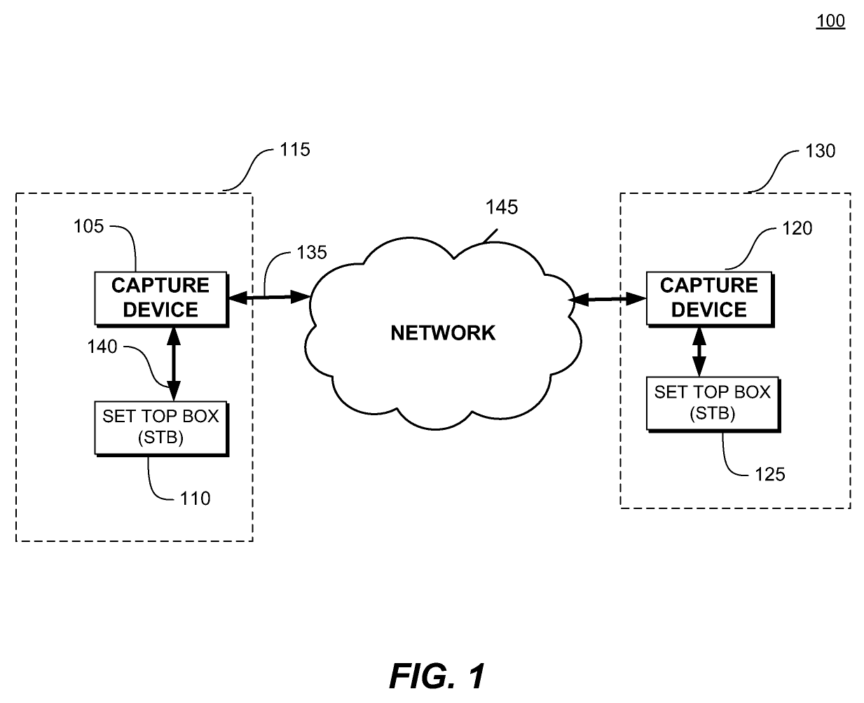

FIG. 1 is an exemplary diagram that illustrates a network environment 100 in accordance with a possible embodiment of the invention. When a media production device and a media reproduction device are coupled together the combined device is a Media system. In particular, the network environment 100 may include a plurality of endpoints or network nodes 115 and 130, each network node has a first capture device 105 and a second capture device 120, coupled to each capture device is a set top box (STB) such as first STB 110 and second STB 125 all connected via network 145. Network 145 includes but is not limited to 2-4 G, Internet, Ethernet, WiFi, and Bluetooth networks. When network 145 is an asynchronous network each network node has its own independent clock or at a minimum at least two independent clocks.

The asynchronous network nodes such as network node 115 may be a MPEG player, satellite radio receiver, AM/FM radio receiver, satellite television, portable music player, portable computer, wireless radio, wireless telephone, portable digital video recorder, a Media system, handheld device, cellular telephone, mobile telephone, mobile device, personal digital assistant PDA), or combinations of the above, for example.

The Media system performs full-duplex audio and video communication between different network nodes or endpoints. Each media production device or media system has at a minimum an audio and video capture device and an audio and video output device such as a Set Top Box. The capture and output devices have separate clocks for encoding and decoding purposes. Thus when exchanging packets between Media system endpoints there are at least four independent clock sources. A video clock (V_{N}) at the video device and a STB clock (S_{N}) at the Set Top Box, where “N” is the network node or endpoint. In actuality there may be several other clocks used at each Media system that have no influence on the exchange of packets between endpoints. Further, the four clock sources (V₁, S₁, V₂, S₂) are related to media capture and output. For instance, most of the video devices will run off a fixed 27 MHz clock source (V_{N}). But a separate 27 MHz VCXO, controlled by the video device, will be used to derive the sample clock (S_{N}) that in turn synchronizes the audio samples to the device.

The plurality of capture devices such as capture device 105 comprise a microphone for producing audio signals, camera for producing video signal, and a processing platform such as the Davinci® video platform with a DM6446 evaluation module (EVM). The DM6446 features robust operating systems support, rich user interfaces, high processing performance, and long battery life through the maximum flexibility of a fully integrated mixed processor solution. The peripheral set includes: configurable video ports; a Ethernet MAC (EMAC) with a Management Data Input/Output (MDIO) module; an inter-integrated circuit I2C) Bus interface; audio serial port (ASP); general-purpose timers; watchdog timer; general-purpose input/output (GPIO) with programmable interrupt/event generation modes, multiplexed with other peripherals; UARTs with hardware handshaking support; pulse width modulator PWM) peripherals; and external memory interfaces: an asynchronous external memory interface (EMIFA) for slower memories/peripherals, and a higher speed synchronous memory interface for DDR2.

The DM6446 device includes a Video Processing Subsystem (VPSS) with two configurable video/imaging peripherals: Video Processing Front-End (VPFE) input used for video capture, Video Processing Back-End (VPBE) output with imaging co-processor (VICP) used for display. The Video Processing Front-End (VPFE) is comprised of a CCD Controller (CCDC), a Preview Engine (Previewer), Histogram Module, Auto-Exposure/White Balance/Focus Module (H3A), and Resizer. The CCDC is capable of interfacing to common video decoders, CMOS sensors, and Charge Coupled Devices (CCDs). The Previewer is a real-time image processing engine that takes raw imager data from a CMOS sensor or CCD and converts from an RGB Bayer Pattern to YUV4. The Histogram and H3A modules provide statistical information on the raw color data for use by the DM6446 . The Resizer accepts image data for separate horizontal and vertical resizing from ¼× to 4× in increments of 256/N, where N is between 64 and 1024.

The capture devices produce a data stream 140 consisting of audio packets and video packets, which respectively contain the audio and video data. Data stream 140 can communicated to another network node or exchanged between the capture device 105 and the set top box 110 in the form of local traffic or intra-node communication. Data stream 140 in most cases is audio and video data that can be reproduced by a set top box such as STB 110 into an audio signal to be produced by a speaker system and a video signal to be produced by a TV monitor or other video generating devices. The capture devices such as capture device 105 can also format the captured data into data packets 135 to transmit to another video device, another capture device, or another media production device through an asynchronous network node according to an asynchronous network media access protocol. In inter-node communication, data packet 135 originates in either network node 115 or network node 130. Data packets 135 received at second capture device 120 are processed so as to be reproduced by STB 125. STB 125 and STB 110 are substantially identical and operate in a similar fashion.

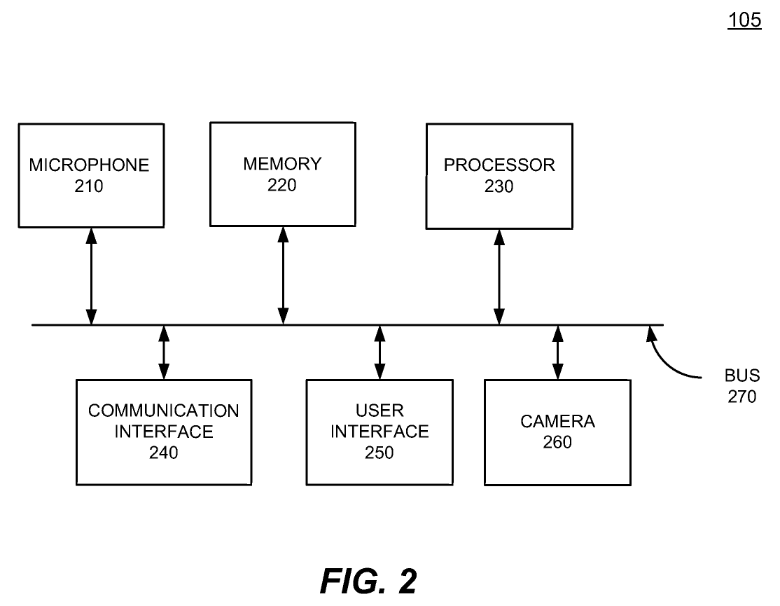

The network environment 100 illustrated in FIG. 1 and the related discussion are intended to provide a brief, general description of a suitable computing environment in which the invention may be implemented. Although not required, the invention will be described, at least in part, in the general context of computer-executable instructions such as program modules, computer program embodied in a computer readable medium and operable when executed to perform steps, being executed by the video device such as VIM 105 and STB 110. Generally, program modules include routine programs, objects, components, data structures, and the like that perform particular tasks or implement particular abstract data types. Moreover, those skilled in the art will appreciate that other embodiments of the invention may be practiced in communication network environments with many types of communication equipment and computer system configurations which operate from batteries, including cellular network devices, mobile communication devices, portable computers, hand-held devices, portable multi-processor systems, microprocessor-based or programmable consumer electronics, and the like. Embodiments may also be practiced in distributed computing environments where tasks are performed by local and remote processing devices that are linked (either by hardwired links, wireless links, or by a combination thereof through a communications network. In a distributed computing environment, program modules may be located in both local and remote memory storage devices. The video device 105 is described further below in relation to FIG. 2.

FIG. 2 is an exemplary diagram that illustrates a capture device 105 in accordance with a possible embodiment of the invention. The capture device 105 may include microphone array 210, memory, processor 230, communication interface 240, user interface 250, and camera 260.

Processor 230 may include at least one conventional processor or microprocessor that interprets and executes a set of instructions. Memory 220 may be a random access memory (RAM) or another type of dynamic storage device that stores information and instructions for execution by processor 230. Memory 220 may also include a read-only memory (ROM which may include a conventional ROM device or another type of static storage device that stores static information and instructions for processor 230.

Communication interface 240 may include any mechanism that facilitates communication via network 145. For example, communication interface 240 may include a modem. Alternatively, communication interface 240 may include other mechanisms like a transceiver in communicating with other devices or systems via wireless connections. User interface 250 may include one or more conventional input mechanisms that permit a user to input information, communicate with the capture device, and present information to the user, such as an electronic display, microphone, touchpad, keypad, keyboard, mouse, pen, stylus, voice recognition device, buttons, one or more speakers.

Microphone 210 is used for picking up the audio signals of a user of the capture device. A second microphone could be used to capture stereo sound signals Camera 260 is a single camera or a camera array comprising one or more still or video electronic cameras, e.g., CCD or CMOS cameras, either color or monochrome or having an equivalent combination of components that capture an area. Motion and operation of each camera 260 may be controlled by control signals, e.g., under computer and/or software control. Moreover, operational parameters for camera 260 including pan/tilt mirror, lens system, focus motor, pan motor, and tilt motor control are controlled by control signals from a controller such as processor 230.

The capture device 105 may perform with processor 230 input, output, communication, programmed, and user-recognition functions by executing sequences of instructions contained in a computer-readable medium, such as, for example, memory 220. Such sequences of instructions may be read into memory 220 from another computer-readable medium, such as a storage device, or from a separate device via communication interface 240.

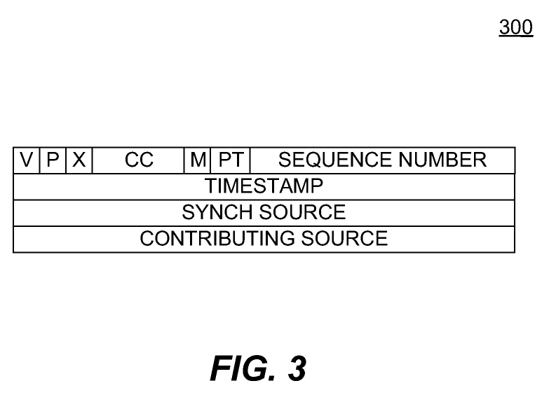

FIG. 3 is a format diagram of a Real-Time Transport Protocol (RTP) header 300 in accordance with a possible embodiment of the invention. In packet networks, one cannot predict a packet's time of arrival from its time of transmission. One packet may reach its destination well before a packet that was transmitted previously from the same source. This is a difference between packet-switched and circuit-switched networks. In circuit-switched networks, a channel is dedicated to a given session throughout the session's life, and the time of arrival tracks the time of transmission. Since the order in which data packets are transmitted is often important, various packet-network transport mechanisms provide the packets with sequence numbers. These numbers give the packets' order. They do not otherwise specify their relative timing, though, since most transmitted data have no time component. However, voice and video data do, so protocols have been developed for specifying timing more completely. A protocol intended particularly for this purpose is the Real-Time Transport Protocol (“RTP”), which is set forth in the Internet Community's Request Comments (“RFC”) 1889. Each frame contains data such as a video sample from a moving scene, for instance, or audio sample typically resulting from sampling sound pressure. The RTP-header field of particular interest here is the timestamp field. Timestamps represent the relative times at which the transmitted samples were taken. Using the timestamps the data can be controlled or arranged to create an audio or video presentation. The timestamps can be used to determine the time the packet was sent, the clock mismatch between the sender and the receiver of the packets, and the best arrival time of the packet at the receiver.

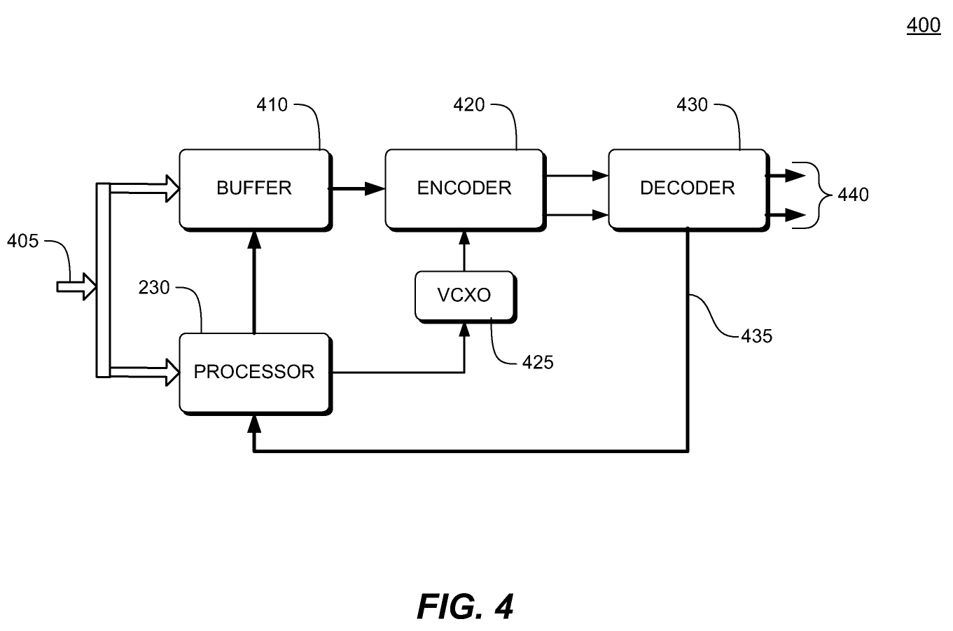

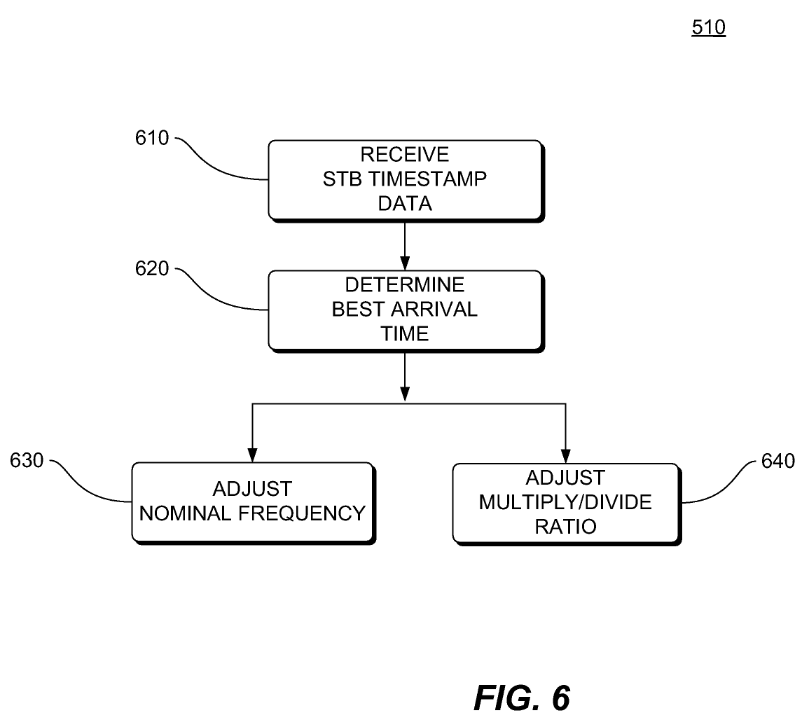

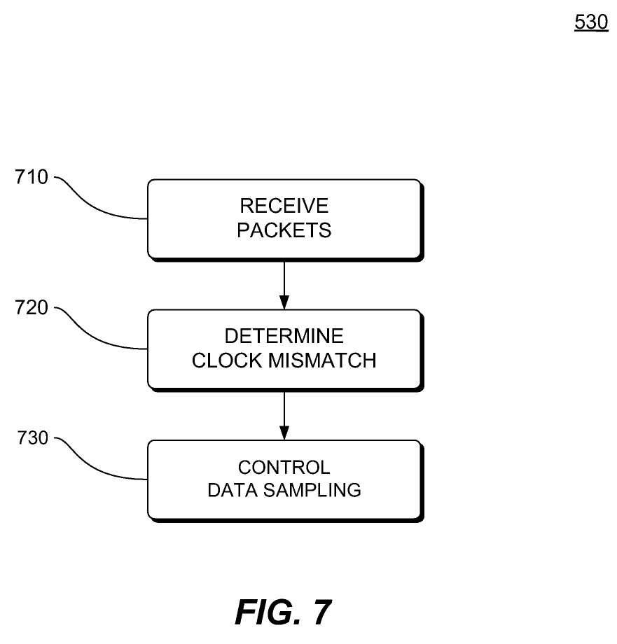

FIG. 4 is a circuit equivalent of a synchronization mechanism 400 in accordance with a possible embodiment of the invention. A multiple synchronization mechanism is useful for synchronizing traffic between a plurality of communication apparatus especially traffic involving multiple nodes and inter-node traffic between different clocked devices. In synchronization mechanism 400 a data stream 405 comprising at least audio and video data is received at buffer 410. Processor 230 implements a software synchronization scheme to synchronize data stream 405 to the receiving device such as capture device 105 from another capture device connected network 145. A software synchronization scheme is especially suited to an arrangement where a plurality of media production devices coupled plurality of media reproduction devices all distributed at a respective network node can be synchronized. The receiving asynchronous network node, receiving capture device, or receiving media production device is synchronized and the received data stream is forwarded to the receiving reproduction device for processing. The software synchronization scheme for inter-node communication is explained in FIG. 7. The data stream is encoded at encoder 420 with clock signal produced by VCXO 425 (voltage-controlled crystal oscillator) also known as the capture clock rate. The encoded signal is received at decoder 430 where video and audio signals 440 are produced for reproduction by speaker and video systems. Additionally, a feedback signal 435 with a timestamp is sent back to processor 230 for implementation of a hardware synchronization scheme. The hardware synchronization scheme for intra-node communication is disclosed in FIG. 6.

In hardware synchronization the set top box is treated as a decoder and correction is only performed at the capture device. The STP is prevented from performing any synchronization because the capture device needs to be aware of the operations performed on the packets. For example, when the capture device performs echo cancellation the post-corrected packet would not be available to the echo canceller running on the capture device. Without the post-corrected packets there would be complications with full duplex systems and could result in poor-quality echo cancellation. Thus, to improve operations it is advisable to try to avoid any corrections from being performed by the STB. If the STB performs estimation, ideally it should find that no correction is necessary. It is, however, possible that the STB will perform a correction infrequently, in which case the echo canceller may perform less than ideally for a brief period of time. In hardware synchronization VCXO 425 is then used to match the capture device to the STB. Since VCXO 425 is synchronized to the set top box any clock mismatch between the different capture devices has to be corrected by using schemes that does not employ VCXO 425.

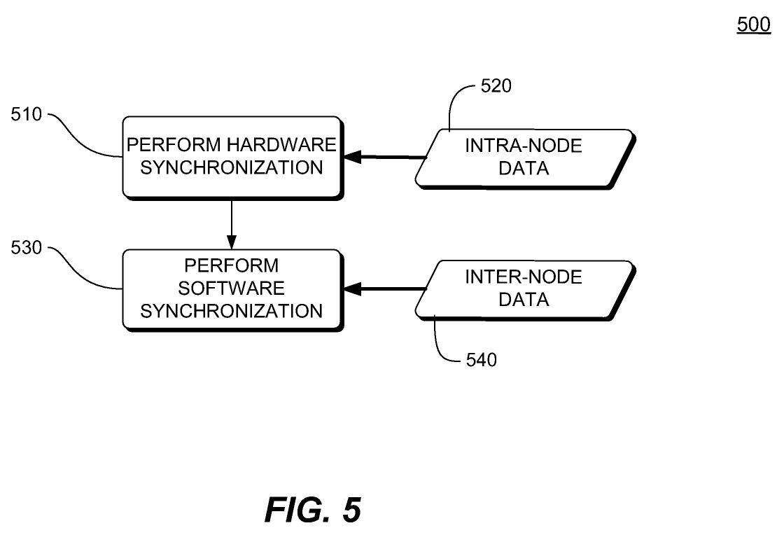

FIG. 5 is a flowchart of process 500 showing a procedure to achieve hardware and software synchronization at a video device in accordance with a possible embodiment of the invention. While process 500 is shown with action 510 and action 530 being interconnected, it should be noted that both of these actions are independent of each other and need not occur sequentially. For example, hardware synchronization 510 could be performed before any packets are received from other nodes. Likewise, the software synchronization 530 could be performed first and hardware synchronization could follow. Process 500 is a macro view of the processing that occurs at each node of network 145 in order to synchronize multimedia traffic between endpoints and local traffic between video device and a set top box. Intra-node data 520 comprising timestamp information from local traffic exchanged between a capture device and a set top box. Inter-node data 540 comprises timestamp information from packets transmitted by another asynchronous network node.

FIG. 6 is a flowchart of method 510 for performing hardware synchronization in accordance with a possible embodiment of the invention. Method 510 begins with action 610, where a processing appliance such as processor 230 receives timestamp data from a set top box. The STB sends a packet to its local capture device with timestamp data that indicates when the packet was sent. In action 620 a determination is made of best arrival time. The best arrival time is an additional action performed by processor 230, FIG. 4, from the timing information such as the transmit timestamp field and the received time stamp field of packets exchanged between the set top box and the video device. The best arrival time is an average time, average time with standard deviation, a running average of sent and receipt or any other statistical scheme that can estimate the clock rate of the decoder such as the STB relative to the capture device.

In action 630, the best arrival time 620 is used for fine-tuning to adjust the nominal frequency of the capture device clock, or local clock, or adjustable clock in the capture device such as VCXO 425. Action 630, actually changes the sample clock rate of the decoder by using external VCXO 425 as the crystal clock source. With the proper control circuits, a VCXO can be adjusted by a small amount around its nominal frequency. The VCXO would be used as the source from which the decoder's sample clock is derived. In the alternative, action 640 adjusts the VCXO's clock rate through a scaling factor or multiply/divide ratio. The VCXO's multiply/divide ratio is a clock recovery or timing extraction circuit capable of locking onto data bits having a bit repetition rate related to the frequency of oscillator VXCO by the ratio or fraction N/M, where each of N and M are integers. It will of course be understood that the frequency and divisor values given herein are for purposes of illustrating a specific example of the invention, and not by way of limiting the invention.

FIG. 7 is a flowchart of method 530 for performing software synchronization in accordance with a possible embodiment of the invention. As noted earlier, timing differences during inter-node communication can be adjusted by using a software synchronization scheme. In action 710, method 530 begins with the reception of packets transmitted by another asynchronous network node. The received packets comprise data of a first type such as video and data of a second type such as audio. In action 720, method 720 determines clock mismatch from the received packets. As noted above in FIG. 1 a plurality of media production devices are connected at different nodes of network 145. The packets from the plurality of media production devices timing information is processed to determine the difference between the clock rates of the respective media production device. Clock mismatch can be determined in a couple of ways. The first way, a buffer-based estimation (BBE) technique uses the fullness or other related dynamic metrics of a data buffer. BBE schemes uses the rate at which the buffer is getting too full or filling up over time to conclude that the decoder clock is slower than the encoder is. Alternatively if the buffer is getting too empty or emptying out over time then the decoder clock is faster. The second way is a timestamp-based estimation (TBE) technique. An example of the TBE technique is to use a Software Phase Lock Loop (PLL) on timestamps transmitted from encoder to decoder to estimate the encoder clock rate relative to the decoder. In a video device the audio jitter buffer could be used for the BBE and the audio Real Time Protocol (RTP) or Real Time Control Protocol (RTCP) time stamps could be used for the TBE. Once the clock mismatch has been determined in action 720 control passes to action 730 to implement a correction when one is needed.

As noted above the hardware synchronization has been reserved for local traffic or packets transmitted to the set top box by the video device. When audio quality is a key evaluation factor the Software-based Correction for audio should do more than trivial sample drop or repeat. In sample drop the number of samples is decreased to accommodate faster traffic arriving at the video device. In sample repeat the number of samples has to be increased to accommodate slower traffic arriving at the video device.

The data sampling could be controlled by using three playback rate settings (slower/normal/faster) and use bilinear or bicubic interpolation to implement “slower” and “faster.” For example, “slower” might interpolate to create 5% more samples, and “faster” might interpolate to create 5% fewer samples. The actual percentage adjustment likely impacts the complexity of the interpolation filter, so 5% may not turn out to be a good choice. On the other hand, larger percentage adjustments may result in more noticeable changes in audio pitch and more oscillation between “slower” and “faster.” The Software-based Correction for video must be carefully coordinated to the correction for audio. The actual Correction method for video will probably need to be frame skip/repeat. Video timestamp adjustment at the Set Top Box could be used to adjust presentation times based on the MPEG-2 transport stream or H.264 SEI picture timing timestamps.

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, et cetera, that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

In particular, one of skill in the art will readily appreciate that the names of the methods and apparatus are not intended to limit embodiments. Furthermore, additional methods and apparatus can be added to the components, functions can be rearranged among the components, and new components to correspond to future enhancements and physical devices used in embodiments can be introduced without departing from the scope of embodiments. One of skill in the art will readily recognize that embodiments are applicable to future communication devices, different file systems, and new data types. Accordingly, the appended claims and their legal equivalents should only define the invention, rather than any specific examples given.

We claim:

1. A method to synchronize multimedia in asynchronous network nodes, each asynchronous network node having at least two independent clocks and transmitting and receiving packets to and from the asynchronous network nodes according to an asynchronous network media access protocol, comprising:
adjusting the at least two independent clocks at each asynchronous network node to synchronize local traffic;
determining at each asynchronous network node a clock mismatch from the reception by the asynchronous network node of packets transmitted by another asynchronous network node; and
controlling data sampling or timestamps at the receiving asynchronous network node based on the determined clock mismatch of the packets transmitted by another asynchronous network node.

2. The method of claim 1, the method further comprising:
determining from a transmit timestamp field a best arrival time for the local traffic at each asynchronous network node.

3. The method of claim 2, wherein adjusting is nominal frequency adjustment of the local clock based on the best arrival time for the local traffic.

4. The method of claim 2, wherein adjusting is adjustment of a scaling factor based on the best arrival time for the local traffic.

5. The method of claim 1, wherein determining clock mismatch at each asynchronous network node is based on buffer estimation or timestamp-based estimation.

6. The method of claim 5, wherein controlling is changing data sampling rate at the receiving asynchronous network node.

7. The method of claim 1, wherein changing data sampling at the receiving asynchronous network node is a software-based correction on a first type of samples and a software-based correction on a second type of samples that is coordinated to the software-based correction on the first type of samples.

8. Communication apparatus, comprising:
a plurality of media production devices each with an adjustable clock, which are connected to communicate over an asynchronous network and are configured to capture data and to transmit the captured data;
a plurality of media reproduction devices electrically coupled to one of the plurality of media production devices and configured to reproduce at least a first type of signal and a second type of signal and to transmit back to the coupled one of the plurality of media production devices timing information; and
a processor in each of the plurality of media production devices, the processor capable of executing a set of instructions to perform actions that include:
fine-tuning the adjustable clock based on the timing information from the media reproduction device;
determining at each media production device a clock mismatch from the reception of packets transmitted over the asynchronous network by another media production device;
controlling data sampling or timestamps at the receiving media production device based on the determined clock mismatch of the packets transmitted by another media production device.

9. The apparatus of claim 8, wherein when fine-tuning the adjustable clock based on the timing information the processor executes the set of instructions to perform additional actions that include:
determining from the timing information a received time for packets transmitted from the media production device to the media reproduction device.

10. The apparatus of claim 9, wherein adjusting is nominal frequency adjustment of the adjustable clock based on the received time for packets transmitted from the media reproduction device to the media production device.

11. The apparatus of claim 9, wherein fine-tuning the adjustable clock is adjusting a multiply/divide ratio based on the received time for packets transmitted from the media reproduction device to the media production device.

12. The apparatus of claim 8, wherein determining clock mismatch at each media production device is based on buffer estimation or timestamp-based estimation.

13. The apparatus of claim 12, wherein controlling is changing data sampling at the receiving media production device.

14. The apparatus of claim 8, wherein changing data sampling at the receiving media production device is a software-based correction on a first type of samples and a software-based correction on a second type of samples that is coordinated to the software-based correction on the first type of samples.

15. A method to synchronize the exchange of multimedia between a plurality of capture devices with capture clock and a plurality set top boxes through an asynchronous network, the method comprising:
performing hardware synchronization at each capture device for controlling intra-node communication, wherein intra-node communication occurs between a capture device and a set top box; and
performing software synchronization at each capture device for controlling inter-node communication, wherein inter-node communication occurs between capture devices through the asynchronous network.

16. The method of claim 15, wherein performing hardware synchronization is adjusting the capture clock to synchronize the intra-node communication.

17. The method of claim 16, wherein adjusting is nominal frequency adjustment of the capture clock based on the best arrival time of a first type of packets and a second type of packets at the set top box.

18. The method of claim 16, wherein adjusting is adjustment of a scaling factor based on the best arrival time of a first type of packets and a second type of packets at the set top box.

19. The method of claim 15, the method further comprising:
estimating at each capture device a best arrival time for packets transmitted by another capture device, wherein estimating is based on buffer estimation or timestamp-based estimation;
wherein performing software synchronization is changing data sampling at the receiving capture device based on the estimation of best arrival time.

20. The method of claim 19, wherein changing data sampling at the receiving capture device is a software-based correction on the first type of samples and a software-based correction on the second type of samples that is coordinated to the software-based correction on the first type of samples.
